(19) United States
(12) Patent Application Publication
(10) Pub. No.: US 2006/0240983 A1
(43) Pub. Date: Oct. 26, 2006

(54) Seed coating composition, coated seed, and coating method

(75) Inventor: Tetsuhiko Yamaguchi, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 10/566,183

(22) PCT Filed: Jul. 23, 2004
(86) PCT No.: PCT/JP04/10871

§ 371 Date: Jan. 27, 2006

Related U.S. Application Data
(60) Provisional application No. 60/493,458, filed on Aug. 8, 2003.

(30) Foreign Application Priority Data
Jul. 31, 2003 (JP) 2003-283696

(51) Int. Cl. A01C 1/06

(52) U.S. Cl. 504/100; 47/57.6

(57) ABSTRACT

An object of the present invention is to provide a seed coating composition capable of enhancing a germination rate of seeds even in environment where seeds are liable to be dried, a coated seed having been coated with the composition, and a seed coating method. The seed coating composition of the present invention comprises a water absorbing resin and a granulating material, said water absorbing resin being obtained by copolymerizing a monomer mixture containing N-vinylcarboxylic acid amide represented by the following formula (1) and a crosslinking monomer; (1) wherein R¹ is a hydrogen atom, a methyl group or a phenyl group, R² is a hydrogen atom, an alkyl group of 1 to 4 carbon atoms or a phenyl group, and R¹ and R² may be the same or different.

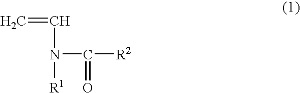

### CROSS REFERENCE OF RELATED APPLICATION

This application is an application filed under 35 U.S.C. §111(a) claiming benefit pursuant to 35 U.S.C. §119(e) of the filing date of Provisional Application 60/493,458 filed on Aug. 8, 2003, pursuant to 35 U.S.C. §111(b).

### DETAILED DESCRIPTION OF THE INVENTION

1. Technical Field

The present invention relates to a seed coating composition used for coating seeds, coated seeds and a seed coating method. More particularly, the invention relates to a seed coating composition capable of inhibiting lowering of a seed germination rate attributable to shortage of water in seeding in the arid land, coated seeds having been coated with the composition, and a seed coating method.

2. Background Art

In cultivation of vegetables, flowers, grains, meadow grasses, etc., management from sowing to germination is extremely important, and the germination rate is an important factor to determine yields. Examples of causes of lowering of the germination rate after sowing include variability of dormant period of seeds, shortage of water content in seeds, excess or shortage of soil moisture after sowing, damage due to pathogenic fungi and damage due to injurious insects. Especially in germination, neither too much nor too little water is necessary around seeds. In case of arid land or slope, watering after sowing is not sufficiently carried out, and lowering of a germination rate is markedly observed.

In recent years, with agricultural mechanization, mechanical sowing of seeds has been performed. In the mechanical sowing, however, there are problems such that it is difficult to uniformly sow extremely fine seeds and the seeds fly from the soil bed.

In order to solve such problems, a method for storing gel coated seeds comprising coating seeds with an aqueous gel containing a water absorbing resin and then drying the gel coated seeds is disclosed in Japanese Patent Laid-Open Publication No. 56707/1993.

In Japanese Patent Laid-Open Publication No. 79802/1982, there is presented a seed composition which has been made favorable for sowing and enhanced in the germination rate by adding an appropriate amount of a water absorbing resin powder capable of absorbing a large amount of water when the soil is aggregated.

The water absorbing resins used in the above publications include a starch/acrylic acid graft polymer, a polyacrylate type resin, an isobutylene/maleic anhydride copolymer and a vinyl acetate/acrylic ester copolymer saponified product, but they are all anionic water absorbing resins. Therefore, if large amounts of inorganic salts, organic materials or fertilizers are contained in the soil or if large amounts of salts or the like are contained in the groundwater, swelling of seeds to prescribed sizes becomes infeasible even when the absorbing resins absorb water, and consequently, the proper object cannot be achieved.

On the other hand, in Japanese Patent No. 2947637, a N-vinylcarboxylic acid amide type water absorbing resin is exemplified. This resin is nonionic, so that even in the presence of salts, it can absorb water and swells without being influenced by the salts. In this publication, there is description of a seed formulation as an example using the water absorbing resin, but detailed description thereof is not given and an effect of the resin is not clarified either. In Japanese Patent No. 3042546, there is description of coating of seeds, fertilizers, agricultural chemicals, etc. as an example of uses of N-vinylcarboxylic acid amide microgel having a crosslinked structure. However, because the microgel is a resin having a high degree of crosslinking and does not swell unlike a water absorbing resin, the microgel has a different function. And besides, details of uses, for example, how much the resin coating should be performed, are not clearly mentioned.

### OBJECT OF THE INVENTION

It is an object of the present invention to provide a seed coating composition capable of enhancing a germination rate of seeds even in environment where seeds are liable to be dried, a coated seed having been coated with the composition, and a seed coating method.

### MEANS TO SOLVE THE PROBLEMS

The present invention comprises the following subjects.

[1] A seed coating composition comprising a water absorbing resin and a granulating material, said water absorbing resin being obtained by copolymerizing a monomer mixture containing N-vinylcarboxylic acid amide represented by the following formula (1) and a crosslinking monomer; 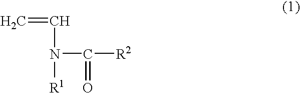
wherein R¹ is a hydrogen atom, a methyl group or a phenyl group, R² is a hydrogen atom, an alkyl group of 1 to 4 carbon atoms or a phenyl group, and R¹ and R² may be the same or different.

[2] The seed coating composition as stated in [1], wherein the monomer mixture further contains a copolymerizable monomer which is copolymerizable with N-vinylcarboxylic acid amide.

[3] The seed coating composition as stated in [2], wherein the copolymerizable monomer is at least one monomer selected from the group consisting of acrylic acid, a salt thereof, (meth)acrylamide-2-methylpropanesulfonic acid, a salt thereof, vinylsulfonic acid and a salt thereof.

[4] The seed coating composition as stated in [2] or [3], wherein the monomer mixture contains the N-vinylcarboxylic acid amide in an amount of not less than 50% by weight and the copolymerizable monomer in an amount of not more than 50% by weight, the sum of the N-vinylcarboxylic acid amide and the copolymerizable monomer being 100% by weight.

[5] The seed coating composition as stated in [1], wherein the crosslinking monomer is used in an amount of 2×10⁻⁴ to 10% by mol based on the N-vinylcarboxylic acid amide.

[6] The seed coating composition as stated in [2], wherein the crosslinking monomer is used in an amount of 2×10⁻⁴ to 10% by mol based on the total of the N-vinylcarboxylic acid amide and the copolymerizable monomer.

[7] The seed coating composition as stated in [1], wherein the water absorbing resin is contained in an amount of 1 to 10 parts by weight based on 100 parts by weight of the granulating material.

[8] The seed coating composition as stated in [1], [5] or [7], wherein the water absorbing resin is a poly(N-vinylacetamide) crosslinked product.

[9] The coated seed according to the present invention is a seed to a surface of which the seed coating composition as stated in any one of [1] to [8] has been bonded with a binder.

[10] The seed coating method according to the present invention is a method comprising coating a surface of a seed with the seed coating composition as stated in any one of [1] to [8].

### MODE FOR CARRYING OUT THE INVENTION

The coated seed according to the invention is prepared by coating a surface of a seed with a seed coating composition. The seed coating composition of the invention comprises a water absorbing resin and a granulating material.

The water absorbing resin (sometimes referred to as a “N-vinylamide type crosslinked product” hereinafter) for use in the invention is obtained by subjecting a monomer mixture containing N-vinylcarboxylic acid amide, a crosslinking monomer, and if necessary, a copolymerizable monomer to (co)polymerization reaction.

These components are described below.

N-Vinylcarboxylic Acid Amide

The N-vinylcarboxylic acid amide for use in the invention is represented by the following formula (1).

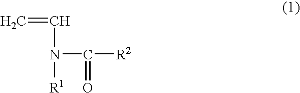

In the formula (1), R¹ is a hydrogen atom, a methyl group or a phenyl group, R² is a hydrogen atom, an alkyl group of 1 to 4 carbon atoms or a phenyl group, and R¹ and R² may be the same or different.

Examples of the N-Vinylcarboxylic Acid Amides include N-vinylacetamide, N-vinylformamide, N-methyl-N-vinylformamide and N-methyl-N-vinylacetamide. Of these, N-vinylacetamide is particularly preferably employed.

Copolymerizable Monomer

The copolymerizable monomer having one polymerizable unsaturated bond in one molecule that is used when needed is a monomer which is copolymerizable with N-vinylcarboxylic acid amide, and examples of such monomers include (meth)acrylic acid, a salt thereof, (meth)acrylamide-2-methylpropanesulfonic acid, a salt thereof, vinylsulfonic acid, a salt thereof, (meth)acrylic ester of lower alkyl substituted with dimethylamino group, and (meth)acrylic ester of lower alkyl substituted with hydroxyl group.

Of the above monomers, acrylic acid, a salt thereof, (meth)acrylamide-2-methylpropanesulfonic acid, a salt thereof, vinylsulfonic acid and a salt thereof, which are excellent in performance and cost, are preferably employed. Examples of the salts include a sodium salt, a potassium salt and an ammonium salt. Other salts are also employable.

The copolymerizable monomer is used in combination with the N-vinylcarboxylic acid amide from the viewpoint of enhancement of water absorption rate of the water absorbing resin. In this case, it is desirable that the N-vinylcarboxylic acid amide is used in an amount of not less than 50% by weight, preferably not less than 60% by weight, more preferably not less than 65% by weight, and the copolymerizable monomer is used in an amount of not more than 50% by weight, preferably not more than 40% by weight, more preferably not more than 35% by weight, the sum of the N-vinylcarboxylic acid amide and the copolymerizable monomer being 100% by weight. There is no specific limitation on the upper limit of the N-vinylcarboxylic acid amide and the lower limit of the copolymerizable monomer.

By the use of the N-vinylcarboxylic acid amide and the copolymerizable monomer in the above amounts, the resulting water absorbing resin can exhibit excellent water absorption performance even in case of an aqueous solution containing electrolyte and ion.

Crosslinking Monomer

Examples of the crosslinking monomers (sometimes referred to as “crosslinking agents” hereinafter) having at least two polymerizable unsaturated bonds in one molecule, which are used in the preparation of the water absorbing resin, include compounds having plural (meth)acrylic groups, such as N,N′-methylenebisacrylamide, triethylene glycol di(meth)acrylate and pentaerythritol tri(meth)acrylate;

N,N′-alkylenebis(N-vinylcarboxylic acid amide) compounds, such as N,N′-butylenebis(N-vinylacetamide) and N,N′-diacetyl-N,N′-divinyl-1,4-bisaminomethylcyclohexane;

compounds having two or more allyl groups, such as diethylene glycol diallyl ether, trimethylolpropane triallyl ether, tetraallyloxyethane, pentaerythritol triallyl ether, diallyl adipate and diallyl terephthalate; and

compounds having two or more vinyl ester structures, such as divinyl oxalate, divinyl succinate, divinyl malonate, divinyl adipate, divinyl maleate, trivinyl citrate and tetravinyl pyromellitate.

These monomers can be used singly, or if necessary, in combination of two or more kinds.

The crosslinking agent is desirably used in an amount of 2×⁻⁴ to 10% by mol, preferably 5×10⁻⁴ to 2% by mol, based on the total of the N-vinylcarboxylic acid amide and the copolymerizable monomer. By the use of the crossinking monomer in this amount, a water absorbing resin having a proper crosslink density is obtained, and therefore, the water absorbing resin can exert excellent water absorbing effect.

Water Absorbing Resin

The water absorbing resin for use in the invention can be prepared by copolymerizing the N-vinylcarboxylic acid amide, the copolymerizable monomer that is used when needed, and the crosslinking monomer in the presence of a radical polymerization initiator and substantially in the absence of oxygen.

Examples of the radical polymerization initiators used include publicly known peroxides, organic or inorganic peracids, salts thereof, and azobis compounds. They are used singly, or they are used in combination with reducing agents, as redox type initiators. Of these, azobis type initiators, such as azobisisobutyronitrile and azobis(2-diaminopropane) dihydrochloride, are particularly preferable. The polymerization initiator is used in an amount of 0.1 part by weight to 8 parts by weight based on 100 parts by weight of the total of monomers. The polymerization initiating temperature is in the range of usually −10 to 80° C., and the reaction time is in the range of usually 0.5 to 30 hours.

Although the (co)polymerization process is not specifically restricted, processes conventionally adopted to prepare sodium polyacrylate crosslinked product, such as an aqueous solution polymerization process, a reversed phase suspension polymerization process and a reversed phase emulsion polymerization process, are adoptable. Examples of such processes are described in Japanese Patent Laid-Open Publication No. 223304/1991, Japanese Patent Laid-Open Publication No. 230250/1992, Japanese Patent Laid-Open Publication No. 346833/1992, etc. An average degree of polymerization of a main chain of the resulting water absorbing resin is in the range of 100 to 500000.

After the N-vinyl carboxylic acid amide (co)polymer is prepared by the above process, the copolymer can be further subjected to post-crosslinking through the reaction of various epoxy compounds, alcohol compounds, amine compounds or isocyanate compounds, each of which has two or more functional groups, divalent or higher metal ions or the like with functional groups derived from the monomer.

In the water absorbing resin, N-vinylcarboxylic acid amide units are desirably contained in amounts of 50 to 100% by weight, preferably 60 to 100% by weight, more preferably 65 to 100% by weight, and copolymerizable monomer units are desirably contained in amounts of 0 to 50% by weight, preferably 0 to 40% by weight, more preferably 0 to 35% by weight, the sum of the N-vinylcarboxylic acid amide units and the copolymerizable monomer units being 100% by weight.

If the amounts of the copolymerizable monomer units are more than 50% by weight, water absorption performance of the water absorbing resin to absorb an electrolyte-containing or ion-containing aqueous solution is lowered, so that such amounts are unfavorable. This point is described below with reference to an example using sodium acrylate as the copolymerizable monomer.

For example, a water absorbing resin composed of 100% by weight of N-vinylcarboxylic acid amide units (sodium acrylate: 0% by weight) has an absorption ratio to 1.0% CaCl₂ aqueous solution of about 50 times the weight of the resin itself, as a rough measure, though the ratio varies depending upon the crosslink density and the degree of polymerization. On the other hand, a water absorbing resin composed of 50% by weight of N-vinylcarboxylic acid amide units and 50% by weight of sodium acrylate has an absorption ratio to 1.0% CaCl₂ aqueous solution of about 30 times the weight of the resin itself. A water absorbing resin composed of 50 to 0% by weight of N-vinylcarboxylic acid amide units and 50 to 100% by weight of sodium acrylate has an absorption ratio to 1.0% CaCl₂ aqueous solution of about several times to 0 times the weight of the resin itself and exhibits extremely low water absorption performance, because ion crosslinking attributable to calcium ion takes place.

The liquid absorption ratio is measured in the following manner. About 1.0 g of a water absorbing resin is introduced into about 1 liter of a liquid (e.g., 1.0% CaCl₂ aqueous solution) to allow the resin to absorb the liquid to saturation, followed by filtration using a 200-mesh wire cloth. Then, the liquid absorption ratio is calculated from the following formula.
Liquid absorption ratio=(weight of swollen water absorbing resin/weight of water absorbing resin before liquid absorption)−1

The water absorbing resin for use in the invention is preferably a water absorbing resin obtained by polymerizing the N-vinylcarboxylic acid amide in the presence of a crosslinking monomer. Examples of such water absorbing resins include a poly(N-vinylacetamide) crosslinked product, a poly(N-vinylformamide) crosslinked product and a poly(N-methyl-N-vinylacetamide) crosslinked product. Of these, the poly(N-vinylacetamide) crosslinked product is particularly preferable because it is nonionic, can absorb various salt solutions and has excellent water absorption stability.

Granulating Material

As the granulating material for the seed coating composition of the invention, a commonly used inorganic substance can be used as it is. Examples of such inorganic substances include diatomaceous earth, silica, tuff loam, volcanic ash, feldspar, talc, kaolin, clay, clay mineral, bentonite, zeolite, perlite, vermiculite, aluminum hydroxide and calcium hydroxide. These can be used singly or in combination. An average particle diameter of the granulating material is preferably not more than 20 μm, though the average particle diameter is not specifically limited thereto.

Incorporation of the granulating material into the seed coating composition of the invention is preferable because seeds having been coated with the composition do not fly.

The seed coating composition is prepared by the use of the water absorbing resin and the granulating material. The process for preparing the composition is not specifically restricted, and the water absorbing resin and the granulating material have only to be homogeneously mixed by the process.

From the viewpoints of coating processability and water absorption properties, the amount of the water absorbing resin used is preferably in the range of 1 part by weight to 10 parts by weight based on 100 parts by weight of the granulating material. If the amount of the water absorbing resin is less than 1 part by weight, water cannot be sufficiently retained. If the amount thereof is more than 10 parts by weight, the strength of the coating layer cannot be retained, and the surface of the coated seed is liable to be broken.

To the coating composition, auxiliary components, such as plant hormone, plant nutritive agent, plant growth inhibitor, bactericide and fertilizer, may be added when needed.

In the case where the coated seeds adhere to one another when they are dried, a hydrophobic agent can be added to the coating composition when needed. As the hydrophobic agent, a saturated or unsaturated higher fatty acid, a higher alcohol, or a derivative thereof, each having 12 to 22 carbon atoms, is employed. Examples of preferred hydrophobic agents include stearic acid, metal salts (Na salt, K salt, Mg salt, Ca salt, etc.) of stearic acid, stearyl alcohol and an alkylene oxide adduct of stearyl alcohol. The hydrophobic agent is used by mixing it with the seed coating composition, so that a hydrophobic agent of a fine powder is preferable, and a hydrophobic agent having a particle diameter of not more than 20 μn is usually used, without limiting thereto.

Coated Seed

The coated seed of the invention is a seed whose surface has been coated with the above-described seed coating composition. Because the coated seed has been coated with the seed coating composition as described above, a high germination rate can be obtained even under such conditions that seeds are liable to be dried. Further, if the coated seed is temporarily dried after it absorbs water and swells, the coated seed can easily absorb water again. Moreover, even if the coated seed is brought into contact with water having high concentrations of salts (particularly salinity) in the place where shortage of soil moisture takes place after sowing or in the arid land such as a desert zone, the coated seed can easily absorb water. Consequently, even in environment where seeds are liable to be dried, a high germination rate can be obtained regardless of the soil conditions.

The coated seed of the invention can be prepared by bringing a seed into contact with the seed coating composition with spraying, for example, a liquid binder onto the seed surface and then drying the seed. In the coated seed of the invention, the granulating material is contained in the coating layer, whereby fly of the coated seed is prevented.

As the binder used in the preparation of the coated seed, a hydrophilic resin is available. Examples of the hydrophilic resins include sodium alginate, sodium polyacrylate (0.2% aqueous solution viscosity (20° C.): 500 to 900 cps), ammonium polyacrylate, carboxymethyl cellulose (degree of polymerization: 300 to 500), methyl cellulose (2% aqueous solution viscosity (20° C.): 20 to 5500 cps), casein, gelatin, pullulan, starch, polyvinyl alcohol (degree of polymerization: 500 to 1500, degree of saponification: 70 to 100% by mol), polyacrylamide, polyvinyl pyrrolidone, polyethylene oxide (degree of polymerization: 3000 to 100000), a N-vinylacetamide/sodium acrylate copolymer (weight-average molecular weight: 10000 to 5000000) and poly(N-vinylacetamide) (weight-average molecular weight: 10000 to 5000000). These hydrophilic resins are usually used in the form of an aqueous solution.

From the viewpoint of coating processability, the binder is desirably added in an amount of 0.1 part by weight to 10 parts by weight, preferably 0.5 part by weight to 5 parts by weight, based on 100 parts by weight of the granulating material. If the amount of the binder is less than 0.1 part by weight, not all of the granulating material, the seed, the water absorbing resin, etc. can be bonded and granulated. If the amount thereof is more than 10 parts by weight, viscosity is increased, and as a result, coating becomes infeasible.

For preparing the coated seed, various granulating apparatuses, such as a stepped dish type granulating machine, a collar dish type granulating machine, a conical dish type granulating machine, a conical drum type granulating machine, a multi-stage conical drum granulating machine, a tilted rotary pan type granulating machine, a cylinder type stirring granulating machine, an oscillating cylinder type stirring granulating machine, a conical rotary type stirring granulating machine, a rotary bottom plate combination type stirring granulating machine and a fluidized bed type granulating machine, are employable.

More specifically, seeds are introduced into a granulating apparatus. While the seeds are stirred (rolled) in the granulating apparatus, the seed coating composition is added to the seeds with spraying an aqueous solution in which a binder is dissolved or semi-dissolved. The auxiliary components are mixed with the aqueous solution of the binder, or if an auxiliary component insoluble in water is used, it may be dissolved in a volatile solvent such as alcohol, followed by spraying.

After the seed surface is coated as above, the seed is dried to obtain a coated seed of the invention. If a hardness of the coating layer of the coated seed is too low, an aqueous solution of a divalent or trivalent metal salt (calcium, magnesium, barium or the like) may be further sprayed to insolubilize the binder, whereby the hardness can be increased.

Although the size of the coated seed cannot be determined indiscriminately because original seeds are different in weight and size, the coated seed has only to have such a size that mechanical sowing is feasible. In general, the weight of the coating layer is in the range of 0.3 to 3 times, preferably 0.7 to 1.5 times, the weight of the original seed. By coating the seed surface with the coating composition in such weight, the coated seed can absorb water sufficiently, and even in environment where seeds are liable to be dried, the seed germination rate can be increased.

The type of the seed to be subjected to granulation coating is not specifically restricted, and common seeds or processed seeds, such as seeds from which shells have been removed, namely, so-called peeled seeds, are employable.

### EFFECT OF THE INVENTION

The coated seed of the invention is a seed whose surface has been coated with the seed coating composition of the invention, and hence, a high germination rate can be obtained even under such conditions that seeds are liable to be dried. Further, even if the coated seed is temporarily dried after it absorbs water and swells, the coated seed can easily absorb water again. Moreover, even if the coated seed is brought into contact with water having high concentrations of salts (particularly salinity) in the place where shortage of soil moisture takes place after sowing or in the arid land such as a desert zone, the coated seed can easily absorb water. Consequently, even in environment where seeds are liable to be dried, a high germination rate can be obtained regardless of the soil conditions.

### EXAMPLES

The present invention is further described with reference to the following examples, but it should be construed that the invention is in no way limited to those examples.

### Preparation Example 1

In 750 g of water, 200 g of N-vinylacetamide and 1.0 g of N,N′-diacetyl-N,N′-divinyl-1,4-bisaminomethylcyclohexane were dissolved, and the solution was introduced into a 1-liter three-necked separable flask. The three-necked separable flask was equipped with a nitrogen feed pipe, a thermometer holder and an exhaust tube, and the flask was placed in a constant temperature bath at 30° C. Then, nitrogen was bubbled for 30 minutes at a rate of 1 liter/min to remove dissolved oxygen. Thereafter, to the reaction solution, a solution of 0.40 g of 2,2′-azobis(2-diaminopropane) dihydrochloride in 49.6 g of water was added. The flask was then placed in a heat insulating container, and the nitrogen flow rate was decreased to 0.1 liter/min, followed by allowing the flask to stand still. After 16 hours, the gel-like contents were taken out, finely divided by a mixer, then dehydrated by the use of acetone and dried at 105° C. for 5 hours. The resulting dry gel was pulverized and sieved to adjust the sizes to 48 to 100 meshes. Thus, a crosslinked product of poly(N-vinylacetamide) (water absorbing resin) was prepared. A liquid absorption ratio of the water absorbing resin was measured in the following manner, and as a result, it was 51 times.

Measurement of Liquid Absorption Ratio

About 1.0 g of the water absorbing resin was introduced into about 1 liter of a 1.0% CaCl₂ aqueous solution to allow the resin to absorb the solution to saturation, followed by filtration using a 200-mesh wire cloth. Then, a liquid absorption ratio was calculated from the following formula.
Liquid absorption ratio=(weight of swollen water absorbing resin/weight of water absorbing resin before liquid absorption)−1

### Preparation Example 2

A water absorbing resin was prepared in the same manner as in Preparation Example 1, except that 200 g of N-vinylacetamide was changed to 190 g of N-vinylacetamide and 10 g of sodium acrylate. Then, a liquid absorption ratio of the water absorbing resin was measured in the same manner as in Preparation Example 1, and as a result, it was 26 times.

### Example 1

Perlite and the water absorbing resin obtained in Preparation Example 1 were mixed in a mixing ratio of 97:3 by weight to prepare a coating composition. Separately, 1 kg of Chinese cabbage seeds was placed in a tilted rotary pan. With spraying a 10% aqueous solution of completely saponified polyvinyl alcohol onto the seeds, 200 g of the coating composition was added to the seeds to perform seed coating. The seed coating was carried out until the total weight of the coating composition and the polyvinyl alcohol became 1.2 times the weight of the seeds. Then, the seeds were dried at 40° C. for 15 hours to obtain coated seeds. The germination rate of the coated seeds after 7 days was 98.8%.

Measurement of Germination Rate

Measurement of a germination rate was carried out in the following manner. Two sheets of filter paper were laid in a petri dish having a diameter of 9 cm, and onto the paper, 5 ml of water was poured. Then, 100 coated seeds were put on the paper bed, and the petri dish was placed in a constant temperature room at 25° C. After 7 days, the number of germinated seeds was counted. The same measurements were carried out using 5 petri dishes at the same time, and an average value was determined.

### Example 2

Diatomaceous earth and the water absorbing resin obtained in Preparation Example 1 were mixed in a mixing ratio of 95:5 by weight to prepare a coating composition. Separately, 1 kg of Bermuda grass seeds was placed in a tilted rotary-pan. With spraying a 2% aqueous solution of sodium alginate onto the seeds, 300 g of the coating composition was added to the seeds to perform seed coating. The seed coating was carried out until the total weight of the coating composition and the sodium alginate became 1.3 times the weight of the seeds. Then, the seeds were dried at 40° C. for 15 hours to obtain coated seeds. The germination rate of the coated seeds after 7 days was 98.2%.

### Example 3

Diatomaceous earth and the water absorbing resin obtained in Preparation Example 2 were mixed in a mixing ratio of 95:5 by weight to prepare a coating composition. Separately, 1 kg of Bermuda grass seeds was placed in a tilted rotary pan. With spraying a 2% aqueous solution of sodium alginate onto the seeds, 300 g of the coating composition was added to the seeds to perform seed coating. The seed coating was carried out until the total weight of the coating composition and the sodium alginate became 1.3 times the weight of the seeds. Then, the seeds were dried at 40° C. for 15 hours to obtain coated seeds. The germination rate of the coated seeds after 7 days was 93.6%.

### Comparative Example 1

In a tilted rotary pan, 1 kg of Bermuda grass seeds was placed. With spraying a 10% aqueous solution of completely saponified polyvinyl alcohol onto the seeds, a swollen water absorbing resin, which had been obtained by allowing the water absorbing resin prepared in Preparation Example 1 to absorb water of 20 weight times, was added to the seeds to perform seed coating. The seed coating was carried out until the total weight of the water absorbing resin and the polyvinyl alcohol became 1.3 times the weight of the seeds. Then, the seeds were dried at 40° C. for 15 hours to obtain coated seeds. The germination rate of the coated seeds after 7 days was 92.0%.

### Comparative Example 2

In a tilted rotary pan, 1 kg of Bermuda grass seeds was placed. With spraying a 10% aqueous solution of completely saponified polyvinyl alcohol onto the seeds, a swollen water absorbing agent, which had been obtained by allowing commercially available sodium polyacrylate type water absorbing agent (Aquakeep, produced by Nihon Shokubai Co., Ltd) to absorb tap water of 300 weight times, was added to the seeds to perform seed coating. The seed coating was carried out until the total weight of the water absorbing agent and the polyvinyl alcohol became 1.3 times the weight of the seeds. Then, the seeds were dried at 40° C. for 15 hours to obtain coated seeds. The germination rate of the coated seeds after 7 days was 10.0%.

Liquid Absorption Test

The coated seeds of Bermuda grass obtained in Example 2 and Example 3 were immersed in a fertilizer solution (Knop's solution), and after 3 hours, they were filtered through a 200-mesh wire cloth, followed by measuring increase in weight. Thereafter, the swollen coated seeds were dried and then immersed in a fertilizer solution again, followed by measuring increase in weight.

As a result, the coated seeds of Example 2 swelled and became soft and agar-like in both times. The increase in weight of the coated seeds of Example 2 in the first time and that in the second time were each 50% of the initial weight of the coated seeds. The increase in weight of the coated seeds of Example 3 in the first time and that in the second time were 65% and 20%, respectively, and it can be seen that the water absorbing resin became not easily to swell under the influence of the salts in the fertilizer solution.

Composition of Knop's Solution (wt/vol %)

potassium nitrate: 0.02, calcium nitrate: 0.08, potassium primary phosphate: 0.02, magnesium sulfate: 0.02, iron sulfate heptahydrate: 0.02

1. A seed coating composition comprising a water absorbing resin and a granulating material, said water absorbing resin being obtained by copolymerizing a monomer mixture containing N-vinylcarboxylic acid amide represented by the following formula (1) and a crosslinking monomer; 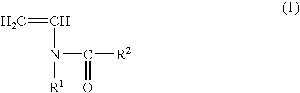
wherein R¹ is a hydrogen atom, a methyl group or a phenyl group, R² is a hydrogen atom, an alkyl group of 1 to 4 carbon atoms or a phenyl group, and R¹ and R² may be the same or different.

2. The seed coating composition as claimed in claim 1, wherein the monomer mixture further contains a copolymerizable monomer which is copolymerizable with N-vinylcarboxylic acid amide.

3. The seed coating composition as claimed in claim 2, wherein the copolymerizable monomer is at least one monomer selected from the group consisting of acrylic acid, a salt thereof, (meth)acrylamide-2-methylpropanesulfonic acid, a salt thereof, vinylsulfonic acid and a salt thereof.

4. The seed coating composition as claimed in claim 2 or 3, wherein the monomer mixture contains the N-vinylcarboxylic acid amide in an amount of not less than 50% by weight and the copolymerizable monomer in an amount of not more than 50% by weight, the sum of the N-vinylcarboxylic acid amide and the copolymerizable monomer being 100% by weight.

5. The seed coating composition as claimed in claim 1, wherein the crosslinking monomer is used in an amount of 2×10⁻⁴ to 10% by mol based on the N-vinylcarboxylic acid amide.

6. The seed coating composition as claimed in claim 2, wherein the crosslinking monomer is used in an amount of 2×10⁻⁴ to 10% by mol based on the total of the N-vinylcarboxylic acid amide and the copolymerizable monomer.

7. The seed coating composition as claimed in claim 1, wherein the water absorbing resin is contained in an amount of 1 to 10 parts by weight based on 100 parts by weight of the granulating material.

8. The seed coating composition as claimed in claim 1, 5 or 7, wherein the water absorbing resin is a poly(N-vinylacetamide) crosslinked product.

9. A coated seed to a surface of which the seed coating composition of any one of claims 1 to 8 has been bonded with a binder.

10. A seed coating method comprising coating a surface of a seed with the seed coating composition of any one of claims 1 to 8.
